(19) United States
(12) Patent Application Publication
(10) Pub. No.: US 2012/0315613 A1
(43) Pub. Date: Dec. 13, 2012

(54) ONLINE PLATFORM FOR LIFESTYLE MANAGEMENT

(75) Inventors: Andrew SHATTE, Phoenix, AZ (US); Adam PERLMAN, Cary, NC (US); Andrew KNIGHT, Waterville Valley, NH (US); Elizabeth DILL, Southborough, MA (US); Jan BRUCE, Waban, MA (US); Richard Pine, New York, NY (US)

(73) Assignee: NEW LIFE SOLUTION, INC., Newton, MA (US)

(21) Appl. No.: 13/434,150

(22) Filed: Mar. 29, 2012

Related U.S. Application Data
(60) Provisional application No. 61/468,782, filed on Mar. 29, 2011.

(51) Int. Cl. G09B 19/00

(52) U.S. Cl. 434/236

(57) ABSTRACT

An online lifestyle management platform designed to address and manage the multiple factors affecting an individual's lifestyle is discussed. The lifestyle management platform may include an assessment evaluation tool used to establish a profile for an individual by assessing the individual's lifestyle factors. The lifestyle factors being assessed may include an individual's physical and mental condition, occupational and personal stress factors and goal satisfaction. Based on the profile, the lifestyle management platform generates a customized lifestyle management program such as a stress management program for the individual.

### RELATED APPLICATION

This application claims the benefit of U.S. provisional patent application No. 61/468,782, filed on Mar. 29, 2011, entitled “Online Platform for Lifestyle Management”, the contents of which are incorporated herein by reference in their entirety.

### BACKGROUND

In recent years, a number of different self-improvement programs have been developed that are directed to improving different aspects of an individual's physical and mental health. These approaches tend to be narrowly targeted to one or two specific areas that an individual is looking to improve. For example, a number of different types of yoga and Pilates programs are directed towards helping an individual to relax while improving their physical condition. Celebrity and other diets promise to help an individual lose weight. Weight Watchers® attempts to reach a similar goal by encouraging an individual to change their behavior and way of thinking about food. Similarly, television broadcasts are filled with offers for different types of exercise equipment designed to work on different specific areas of an individual's body.

Unfortunately the narrow focus of most treatment and improvement regimens fails to adequately address the complex world in which we live. The technological breakthroughs that have revolutionized society and made individuals accessible to their employers and friends twenty-four hours a day, seven days a week, three hundred sixty-five days a year have come at great physical and mental cost to many individuals. Individuals have mental and physical demands from employers, friends and colleagues that are constant and have led to increased stress, an inability to maintain satisfactory physical condition and have led to unhealthy mental approaches to everyday living. Conventional techniques that are narrowly targeted to particular aspects of an individual's mental and physical health fail to address the numerous factors having an effect on an individual's lifestyle.

### BRIEF SUMMARY

Embodiments of the present invention provide a comprehensive online lifestyle management platform designed to address and manage the multiple factors affecting an individual's lifestyle in today's world. The lifestyle management platform includes an assessment evaluation tool used to establish a profile for an individual by assessing the individual's lifestyle factors. The lifestyle factors being assessed include an individual's physical and mental condition, occupational and personal stress factors and goal satisfaction. Based on the profile, the lifestyle management platform generates a customized lifestyle management program for the individual. The lifestyle management program provides behavioral management advice with a focus on positive reinforcement. The lifestyle management program also provides skill building exercises for areas of strength and weakness and provides access to peer support and other community groups. The individual's participation and performance in executing the personalized lifestyle management program is monitored. Online tracking metrics representing the current status of the different components of an individual's lifestyle are continually calculated and updated based on the monitoring.

In one embodiment an interface is provided to a lifestyle management platform. The interface enables an individual to undergo an online assessment of their physical and mental status. The platform also includes an assessment evaluation tool that determines a resiliency score for the individual based on the performance of the individual on the online assessment. The resiliency score is indicative of the overall mental and physical status of the individual. The platform additionally includes a profile generator that generates a customized physical and psychological profile for the individual based on the resiliency score. The profile is used to create a personalized stress management program for the individual. Further, the platform includes a monitoring module that monitors a performance of the individual subsequently following the created stress management program. The profile and resiliency score are adjusted and updated based on the monitored performance.

In another embodiment, a method for providing online lifestyle management includes providing an assessment evaluation tool that determines a resiliency score for an individual undergoing an online assessment of the physical and mental status of the individual. The resiliency score is indicative of the overall mental and physical status of the individual. The method also generates a customized physical and psychological profile for the individual based on the resiliency score and creates a lifestyle management program for the individual based on the profile. Additionally, the method monitors a subsequent performance of the individual following the lifestyle management program and adjusts the profile and resiliency score based on the performance.

In an embodiment, an online lifestyle management platform includes an assessment component that provides access for an individual to an online assessment of physical and mental stress factors for the individual. The assessment component programmatically calculates a score for the assessment. The online lifestyle management platform also includes a program generation component that is used to automatically create a personalized stress management program for the individual based on the score. The online lifestyle management platform further includes a monitoring module that monitors a subsequent performance of the individual in following the created stress management program and adjusts the score based on the performance.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1 depicts an exemplary sequence of steps used by an embodiment of the present invention to generate a personalized lifestyle management program for an individual;

FIG. 2 depicts an exemplary resiliency score in more detail;

FIGS. 3A-3G depict exemplary assessment questions posed to an individual during the online assessment;

FIG. 4 depicts an exemplary usage of the Dashboard in an embodiment of the present invention;

FIG. 5 depicts an exemplary display of the individualized dashboard of the present invention showing an overall value for stress resilience and coping and contributing sub-values from four assessed life dimensions;

FIGS. 6A-6D depict exemplary screenshots providing information to an individual regarding a profile established by the assessment evaluation tool;

FIG. 7 depicts an exemplary community site offered by an embodiment of the present invention through which an individual may share stress levels with others;

FIGS. 8A-8E depict an exemplary exercise sequence provided by an embodiment of the present invention;

FIG. 9A depicts an exemplary environment suitable for practicing embodiments of the present invention; and

FIG. 9B depicts an exemplary Lifestyle Management Platform of the present invention in more detail.

### DETAILED DESCRIPTION

Adverse medical conditions related to lifestyle are increasing in frequency and are leading contributing factors to many of the chronic diseases most often seen in today's medical system. For example, chronic stress is seen as a major cause of obesity, cardio-vascular issues, sleep issues, depression and substance abuse. While narrowly targeted programs for diet, exercise, relaxation and self-help abound, existing processes for helping individuals achieve lasting behavioral and lifestyle change to prevent and/or lessen lifestyle-related adverse medical conditions have been proven ineffective as the processes fail to address the multiple factors affecting the modern individual lifestyle.

The embodiments of the present invention provide always available online mechanisms for identifying and managing the multiplicity of factors affecting an individual's lifestyle. The lifestyle management platform of the present invention treats the entire individual, body and mind, by assessing multiple different aspects of an individual's state of mind and physical well-being. The lifestyle management platform identifies an individual's specific physical and psychological needs and treatments thereof by utilizing a whole body/holistic approach. For example, the lifestyle management platform may analyze the individual's body, mind (including thinking traps and attitudes that create stress), connections (including positive connections to friends, community, family and life purpose) and surroundings (such as relationships to home, work, money, etc.). The lifestyle management platform of the present invention may also help an individual to create self-awareness, build peer support networks and may enable and require rigorous self-measurement and reporting by the individual using the lifestyle management platform.

The lifestyle management platform may utilize integrative medicine and positive psychology in treating an individual. Integrative medicine takes into account the whole person, body, mind and connections, including all aspects of lifestyle. Integrative medicine emphasizes the therapeutic relationship between the doctor or therapist and their patient, makes use of appropriate therapies, both conventional and alternative, and emphasizes lifestyle and prevention. Positive psychology emphasizes an approach that attempts to strengthen already strong aspects of an individual in addition to the more conventional approach of fixing weak and problem areas. Positive psychology includes a focus on nurturing talent, improving quality of life, a refocusing from simply ameliorating negative mood to also boosting positive mood, and teaching life skills that engender a sense of purpose, belonging and well-being.

In one embodiment of the present invention, the lifestyle management platform generates a personalized behavioral management program that targets stress. Stress is caused by a multiplicity of lifestyle factors and is a major contributor to disease and dysfunction in private life and in the workplace. The behavioral management program for stress (hereafter “stress management program”) provides a personalized and measurable stress reduction program that delivers resilience and coping skills, mind/body awareness techniques, diet and exercise plans and a supportive system of coaching and encouragement. By providing continuing and updated assessments of stress factors, the stress management program provides dynamic feedback which may be utilized by an individual to achieve a healthy and well-balanced lifestyle. In addition, the individual may receive customized feedback on how to use the skill based on their current level of facility with the skill, further promoting quality of skill use.

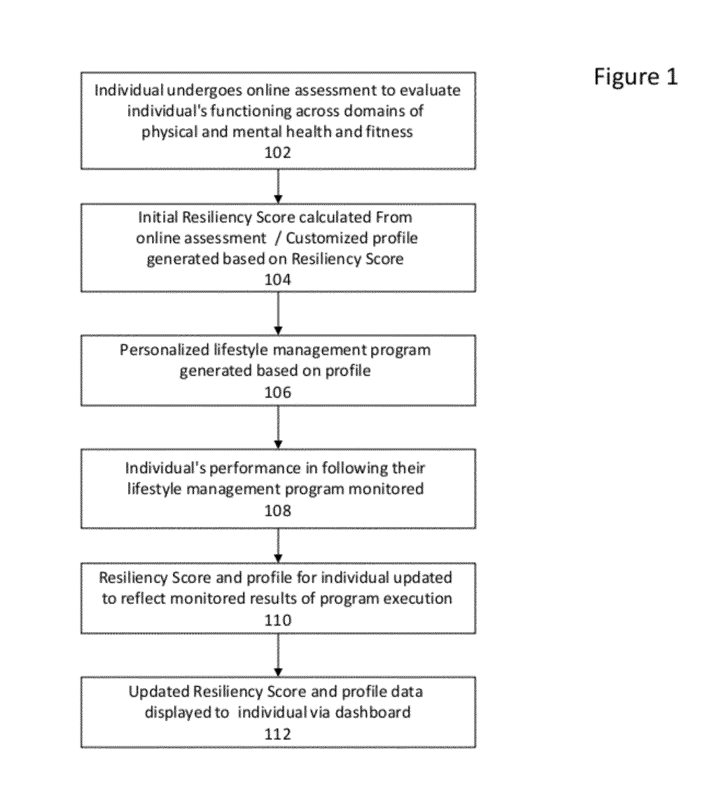

FIG. 1 depicts an exemplary sequence of steps used by an embodiment of the present invention to generate a personalized stress management program for an individual. The sequence begins with an individual undergoing an online assessment offered by the lifestyle management platform (step 102). The online assessment may be performed via a series of questions directed to the individual that focus on different aspects of the individual's physical and mental condition. For example, the online assessment may include a series of questions related to different aspects of the individual's physical and mental condition that impact the individual's lifestyle. These different aspects of the individual's physical and mental condition are referred to herein as “life dimensions.” Exemplary life dimensions may include a Mind life dimension, a Body life dimension, a Connections life dimension and a Surroundings life dimension. Life dimensions are discussed in more detail below. It will be appreciated that other life dimensions are also within the scope of the present invention. The assessment may utilize a series of questions and answers in each dimension to measure each individual's stress symptoms, the lifestyle habits that contribute to stress and the individual's resilience and stress coping strengths and weaknesses.

The lifestyle management platform includes an assessment evaluation tool that may programmatically score the individual's answers to the assessment questions according to pre-defined criteria to calculate an overall resiliency score for the individual. The resiliency score is indicative of the overall mental and physical status of the individual and their current stress coping ability and is calculated using the individual scores for each of the assessed life dimensions. The resiliency score may be used by a profile generator module of the lifestyle management platform to automatically generate a profile for the individual (step 104). Once generated, the profile generator module may use the profile to create a personalized lifestyle management program for the individual (step 106). For example, the profile generator module may use the profile to create a stress management program for the individual. It will be appreciated that the generation of the profile and the creation of the lifestyle/stress management program may also be performed by separate modules rather than a single module without departing from the scope of the present invention. Further, while the description herein discusses various functionality attributed to specific software modules for ease of explanation, it will be appreciated that the modules may be combined or divided in a manner not specifically discussed so as to deliver the same functionality without departing from the scope of the present invention.

Once an individual's lifestyle management program has been created, the individual may access the lifestyle management platform and the created program from a computing device equipped with a browser. As will be explained further below, the lifestyle management platform of the present invention provides a visual dashboard providing access to the user's current profile and personalized lifestyle management program. The individual's personalized lifestyle management program is based on the results of the online assessment and includes a series of exercises in different life dimensions designed to address the specific strengths and weaknesses revealed by the assessment. The personalized programs attempt to further strengthen already strong areas of the individual's physical and mental condition while also building up weaker areas. The order of the exercises and the identity of the exercises may be unique to each individual based upon their particular profile. Additional detail regarding the lifestyle management programs and their execution is provided below.

Continuing with the sequence of FIG. 1, a monitoring module actively monitors the user's subsequent performance in following their personalized lifestyle management program (step 108). As the user performs the exercises and activities in their lifestyle management program, their resiliency score and profile is updated to reflect their current status (step 110). For example completion of assigned exercises in an assigned manner may lead to an increased score while non-compliance with the program, incorrect exercise answers indicative of the individual not processing exercise information, or changes in the individual's life circumstances revealed by the interacting with their personalized lifestyle management program may result in no change or a lower resiliency score. The updated resiliency score and profile information may be displayed to the individual via the dashboard of the present invention (step 112). It should be appreciated that the monitoring module may be implemented as a portion of the individual's lifestyle management program or may be provided as a separate portion of the lifestyle management platform.

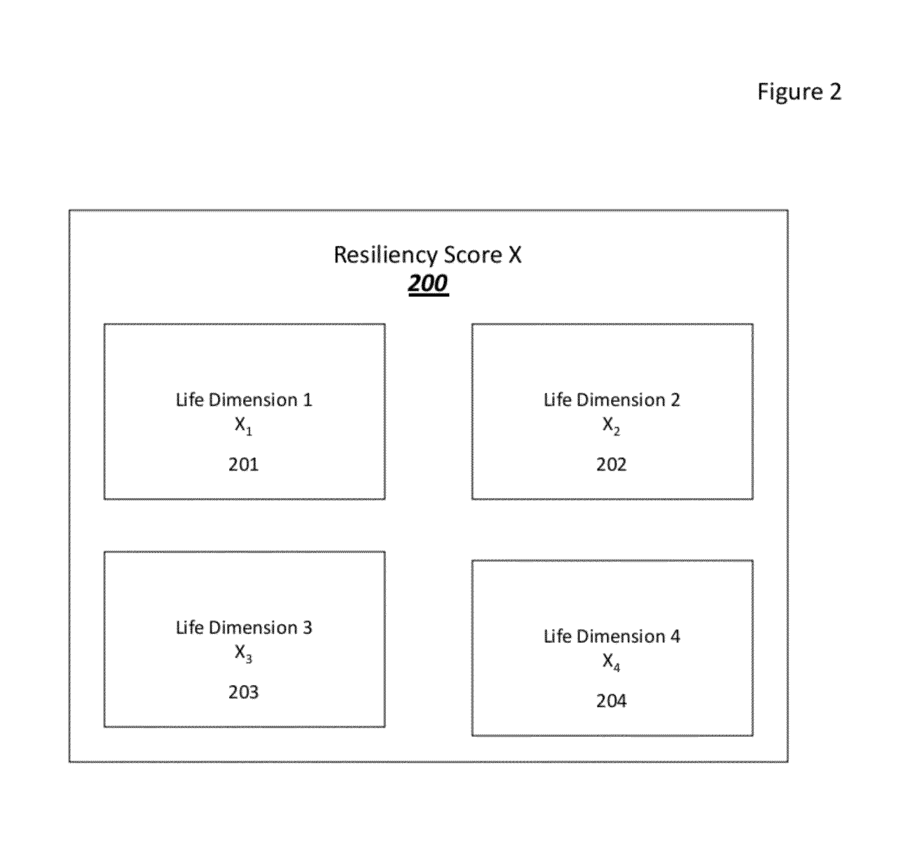

The resiliency score of the present invention provides a single value that is indicative of the individual's physical and mental condition. FIG. 2 depicts an exemplary resiliency score in more detail. The overall resiliency score 200 may be based on all of the assessed life dimensions. For example, in one embodiment, the resiliency score 200 may be a numerical value between 1 and 100 that is calculated based on separate sub-values assigned to the different assessed life dimensions. Thus resiliency score 200 may be the average of sub-values X₁, X₂, X₃ and X₄ for respective life dimension 1 (201), life dimension 2 (202), life dimension 3 (203) and life dimension 4 (204). In one embodiment, life dimension 1 (201), life dimension 2 (202), life dimension 3 (203) and life dimension 4 (204) may respectively be Mind, Body, Connection and Surroundings life dimensions. Exemplary life dimensions assessed by the embodiments of the present invention are discussed in more detail below. The sub-values for the life dimensions may be initially calculated by the assessment evaluation tool as a result of the online assessment and then updated by the monitoring module based on the individual's execution of their customized lifestyle management program. The sub-values may also have individual values between 1 and 100 which may be combined and divided by the number of life dimensions to arrive at the resiliency score. It will be appreciated that in other embodiments the resiliency score may be a weighted average of the sub-values with different weights assigned to different life dimensions based on pre-determined criteria rather than an equally weighted average. Alternatively, the resiliency score may also be based on additional criteria in addition to the sub-values. In another embodiment, the resiliency score and sub-values may be expressed with non-numerical values such as letters.

As noted above, the lifestyle management platform provides an online assessment evaluation tool that calculates a resiliency score based on the individual's answers to the online assessment. The assessment investigates different areas of the individual's life including family situation, network of friends, current life stressors, current level of resilience and coping skills, emotionality, work situation and work-life balance, physical symptoms and connections to job and life. The online assessment utilizes a series of questions and answers to measure each individual's stress symptoms, the lifestyle habits that contribute to stress and the individual's resilience and stress coping strengths and weaknesses. In one embodiment, the assessment is a series of questions rated on a scale of 1 to 5. There may be both positive and negative weighted questions for each dimension. The score of each dimension is based on the sum of the positive and negative questions with different weights assigned to different questions within that dimension. In one embodiment, resilience questions such as those developed by Dr. Andrew Shatté may be utilized along with newly-created questions.

In one embodiment of the present invention, each of the life dimensions, Mind, Body, Connections and Surroundings is tested with 20 questions evenly divided between questions directed to negative forces in the person's life that add to stress and questions attempting to ascertain positive influences which act as a buffer against stress. The individual's answers shape their personalized stress management program. The life dimensions affecting and affected by an individual's overall stress level are important in identifying and treating the underlying causes of an individual's stress.

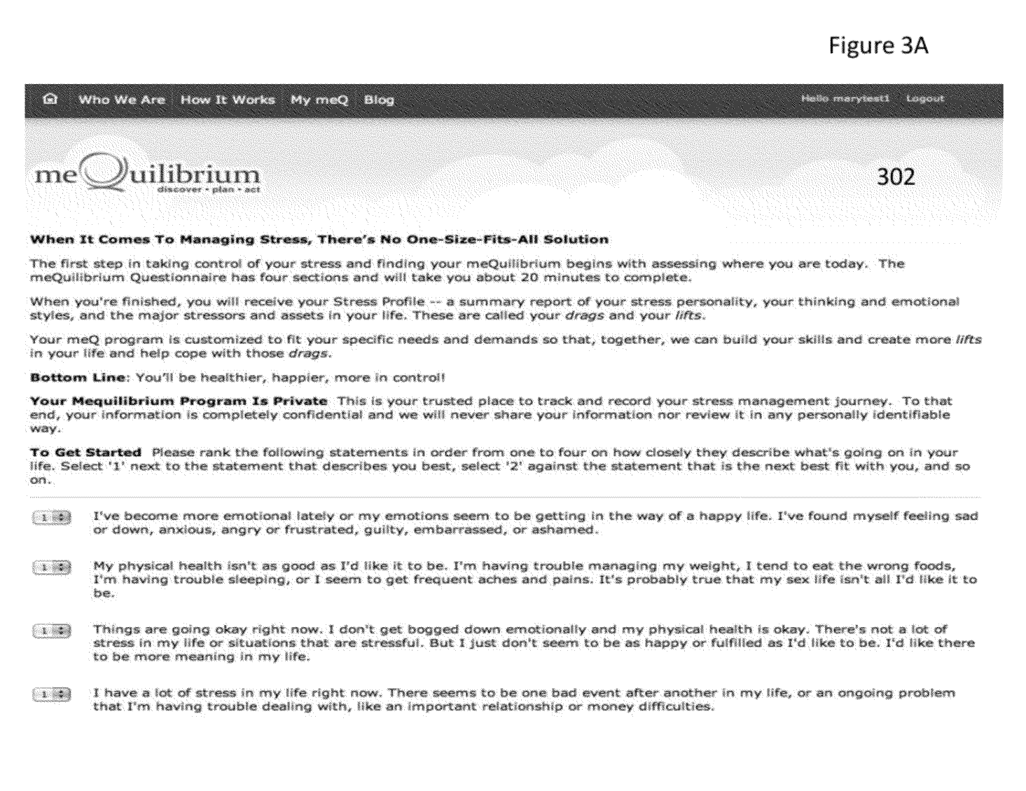

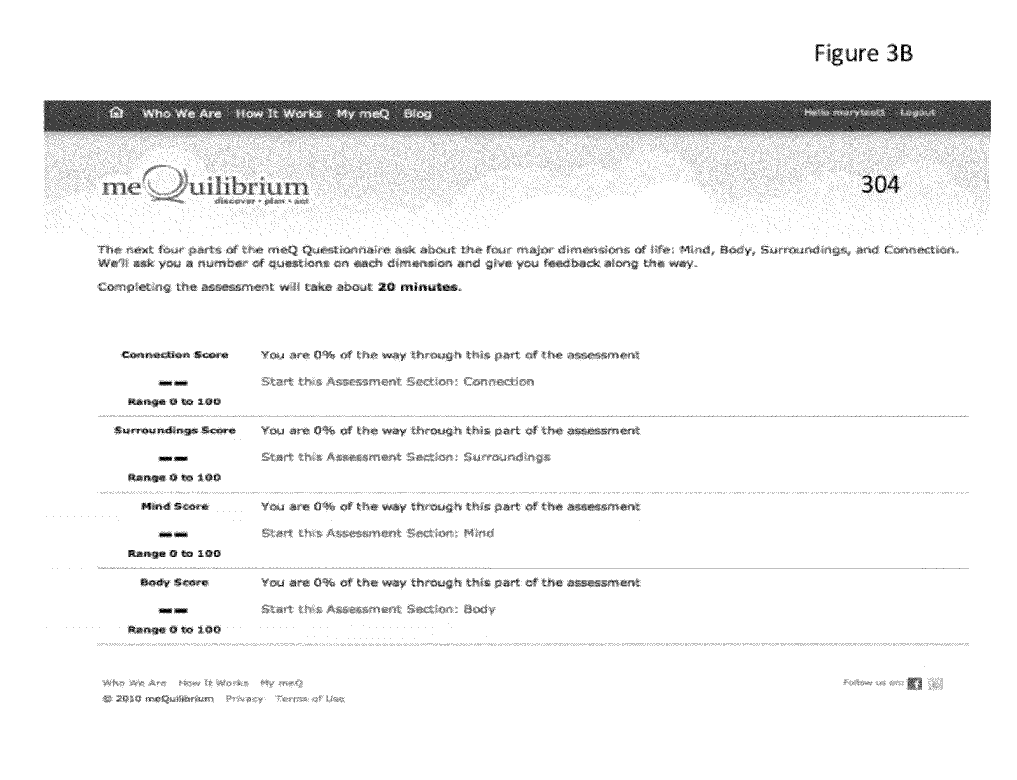

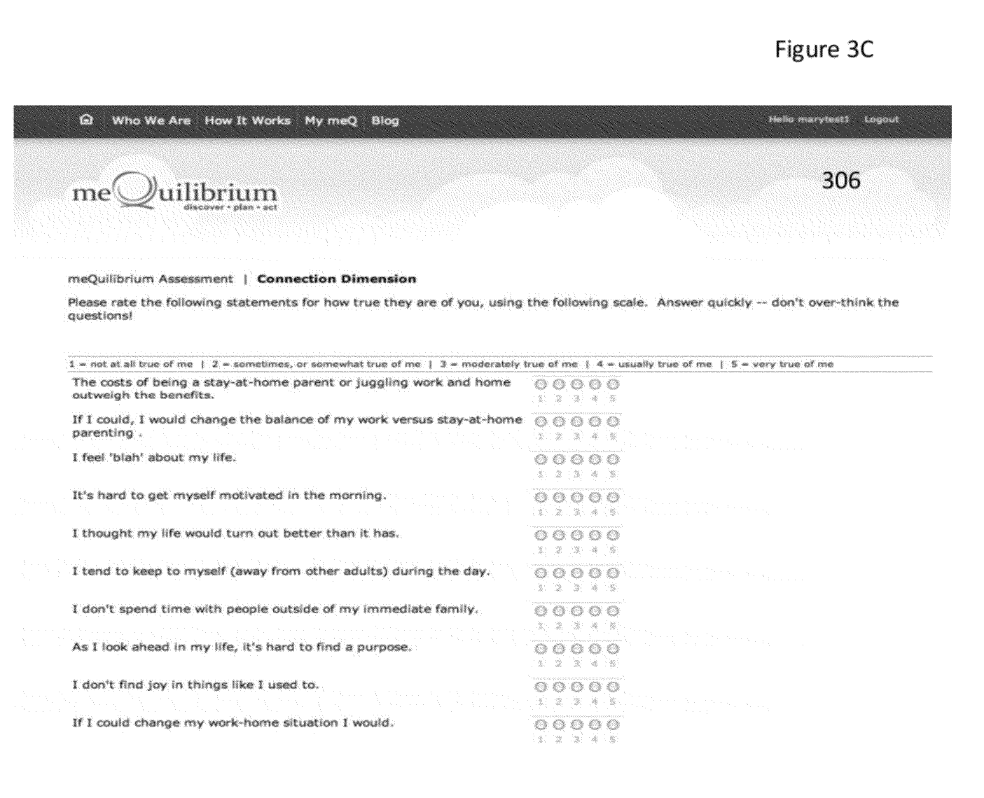

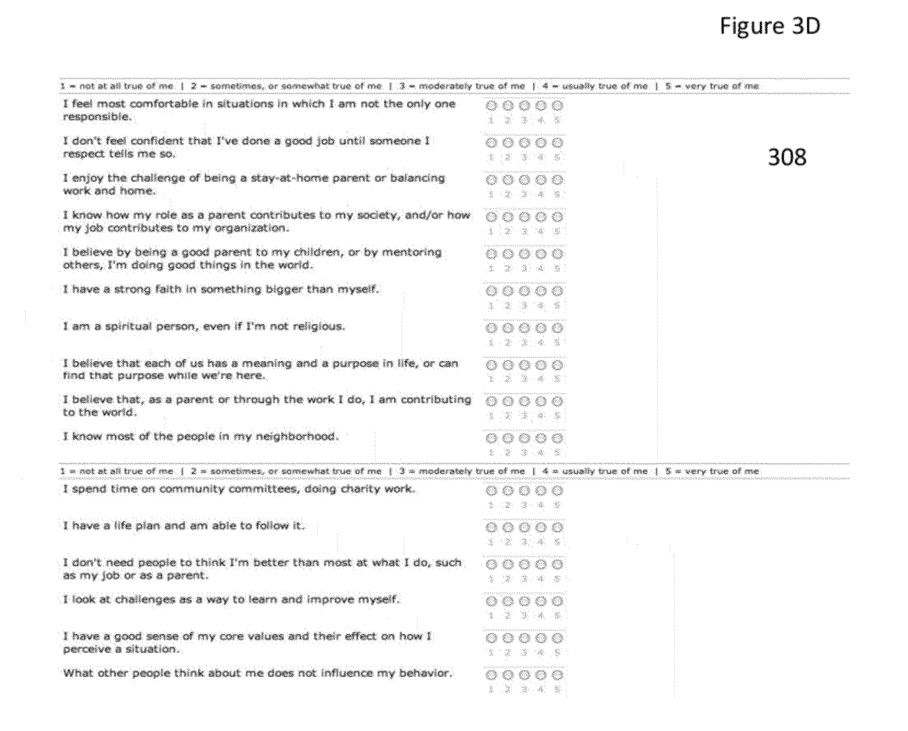

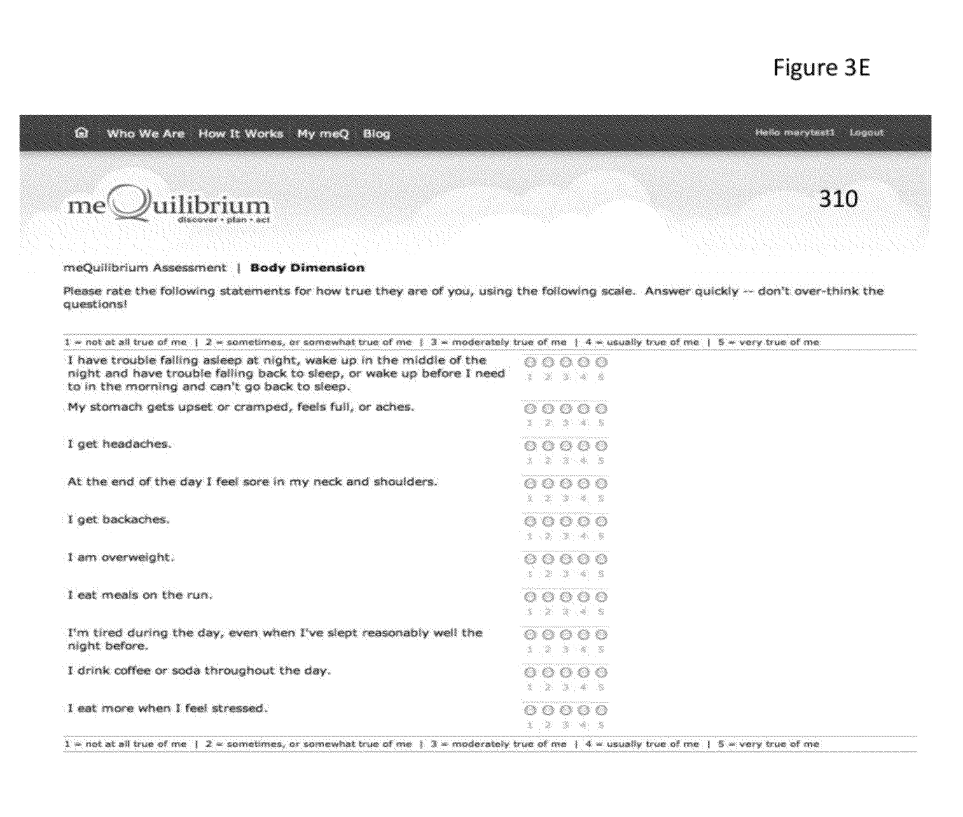

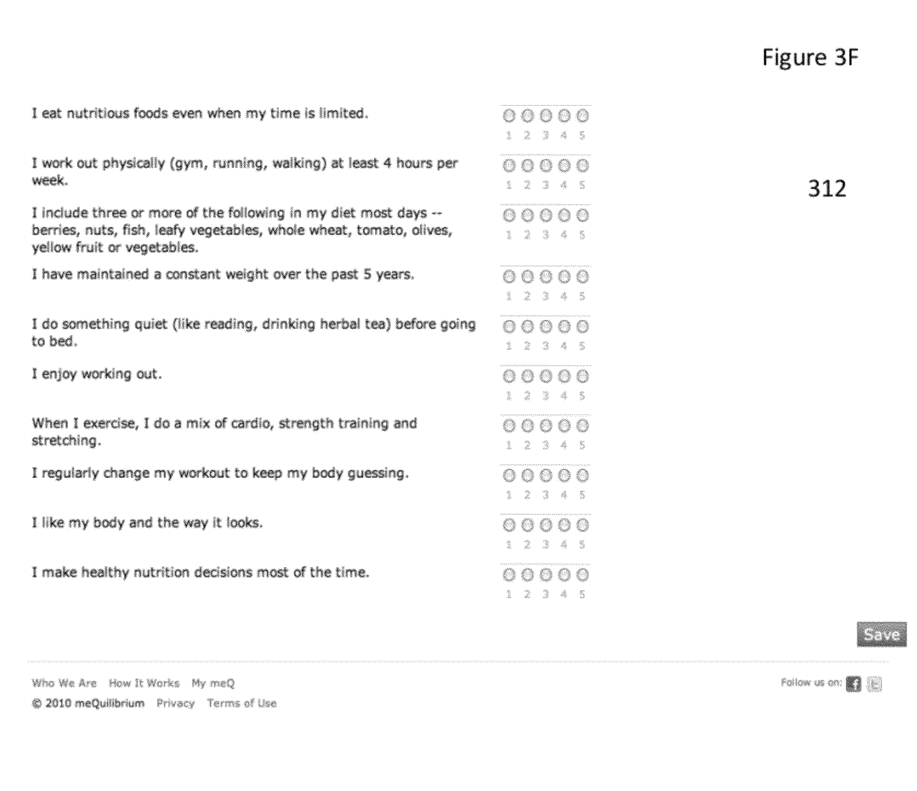

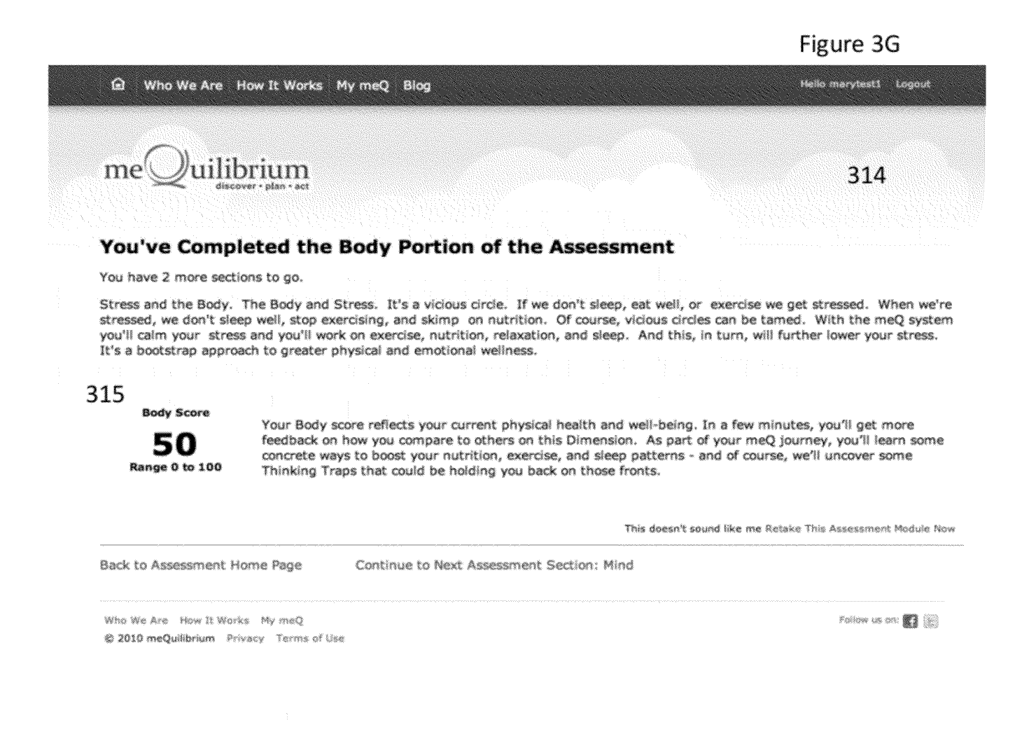

FIGS. 3A-3G depict exemplary questions displayed during the initial online assessment. FIG. 3A depicts exemplary initial questions 302 presented during the online assessment. FIG. 3B presents a status page 304 showing the individual's progress through the questions directed to the different life dimensions. FIGS. 3C and 3D depict pages 306 and 308 of exemplary questions directed to assessing the individual's Connection life dimension. Similarly, FIGS. 3E and 3F depict pages 310 and 312 of exemplary questions directed to assessing the individual's Body dimension. FIG. 3G depicts an exemplary report 314 displaying the initial body score 315 for the individual based upon the individual's answers to the Body life dimension assessment.

The results of the online assessment are used to generate a profile for the individual and to create a personalized stress management program to address each of the life dimensions. For example, in one embodiment, for the Mind life dimension, the created stress management program may attempt to identify, treat and manage potentially debilitating emotional conditions such as sadness and depression, anger management, frustration, chronic worry, panic attacks, general anxiety, guilt, shame, embarrassment, irritability and pessimism Likewise, in the Body life dimension, the stress management program may attempt to identify and treat physical manifestations of stress that often have significant effects on long-term health. The most common physical manifestations caused by stress in the Body life dimension are sleep problems, fatigue, sexual dysfunction, weight management, poor diet and nutrition, lack of exercise, chronic pain, abdominal distress and substance abuse issues. The stress management program attempts to identify and treat the physical manifestations of stress with personalized, multi-disciplinary treatment protocols that may include dietary supplements, nutrition and nutritional counseling, exercise and meditation.

For the Surroundings life dimension, the stress management program may attempt to analyze lifestyle issues that may be contributing to stress and to develop appropriate protocols for dealing with the issues effectively. The stress management program addresses personal, professional and family issues as well as work-related stressors. Exemplary issues identified by the stress management program in the Surroundings life dimension may include the issue of overwork, problems with a child or parenting, aging parents and/or care giving, personal finance problems, problems with family, problems with intimate relationships and issues related to a cluttered home or office.

In a similar vein, the stress management program may analyze the Connections life dimension in an effort to improve the individual's health, spirit and overall sense of well-being, especially in the areas of life satisfaction, career satisfaction, connection to friends and social well-being. Positive psychology principles may be applied by the stress management program to the Connections life dimension in an effort to boost the individual's satisfaction at work and at home, to enhance their connections to causes larger than themselves (which research shows boosts satisfaction and resilience), and to facilitate the individual's search for meaning (whatever that may be for the particular individual). The stress management program may also attempt to identify positive emotions, values and hidden issues (icebergs) of which the individual may not be fully aware.

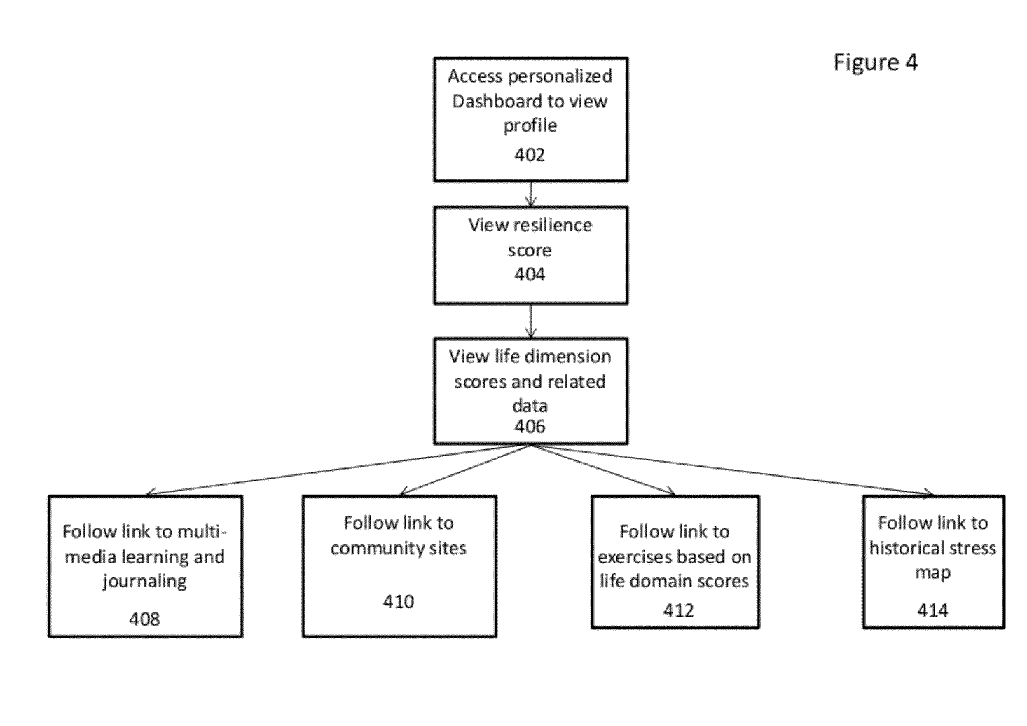

The stress management program is administered through an individualized user interface provided via a personalized virtual dashboard that provides access to the many facets of the stress management program. FIG. 4 depicts an exemplary usage of the dashboard in an embodiment of the present invention. As depicted in FIG. 4, an individual may access their virtual dashboard to view their current stress profile (step 402). The individual profile is dynamic in that it changes over time as a direct result of the individual following, or not following, their stress management program and as a result of changes in individual's life circumstances that are conveyed to the life management platform through the dashboard. The dashboard may display an overall resilience score value and related data indicative of the individual's resilience and ability to cope with stress (step 404) and sub values and related data for each of the assessed life dimensions contributing to the overall resilience score (step 406). These sub-values will change for better or worse based on the individual interacting with the stress management program over time through the dashboard. The interaction of the individual with the dashboard enables the monitoring module of the stress management program (or a separate portion of the lifestyle management portion) to monitor the individual's progress in developing resilience and coping skills both through frequent reassessment and through self-reported metrics. Metric tracking may be enhanced with tools available via the web and handheld devices such as smartphones. The dashboard may also provide the individual with access to interactive multi-media learning and journaling (step 408), provide a link to an online community for support (step 410), provides links to exercises associated with different life dimensions (step 412) and provide access to a historical map of the individual's stress profile (step 414).

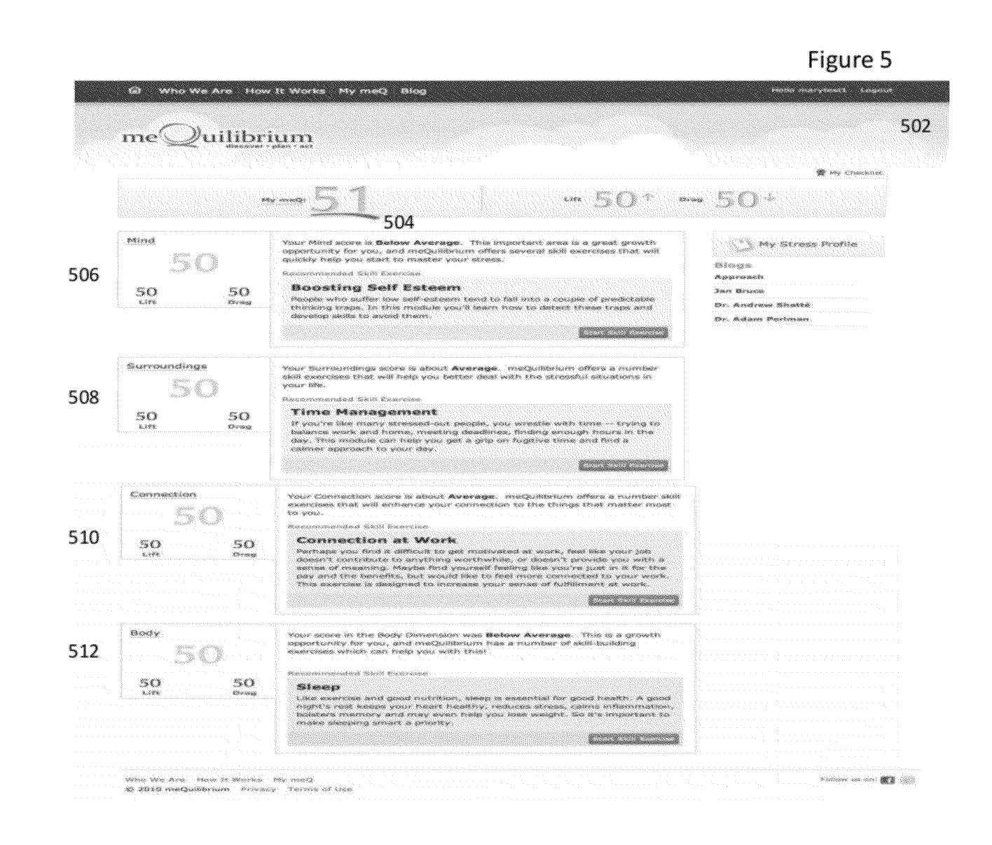

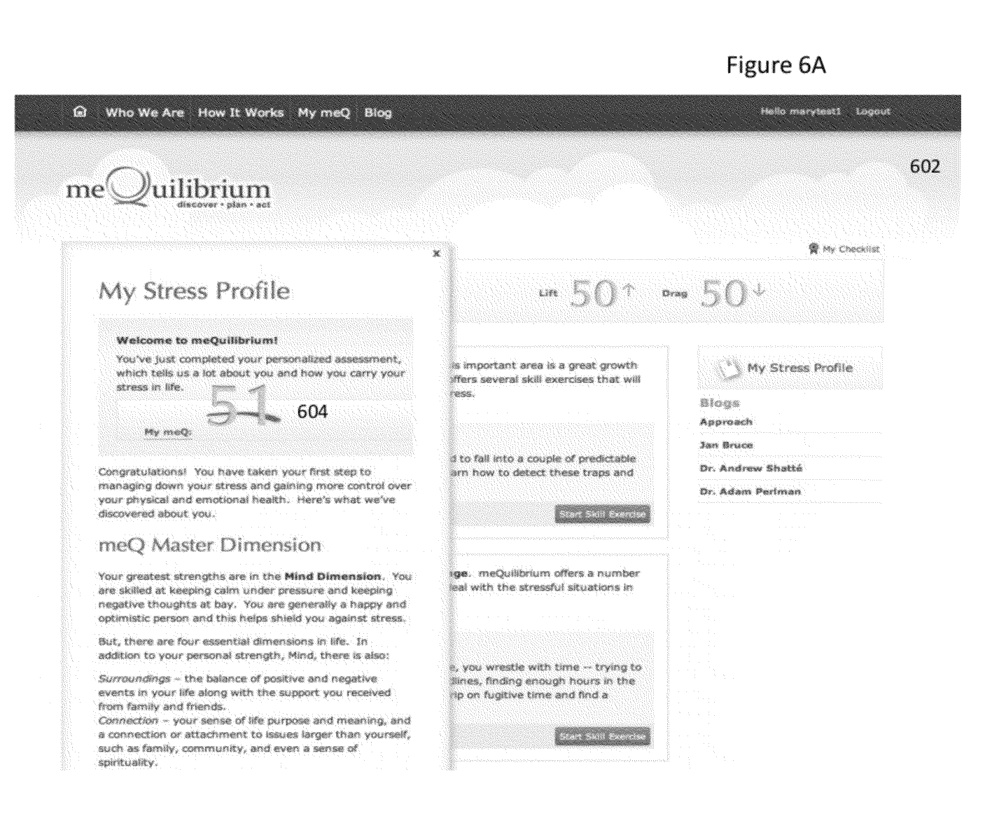

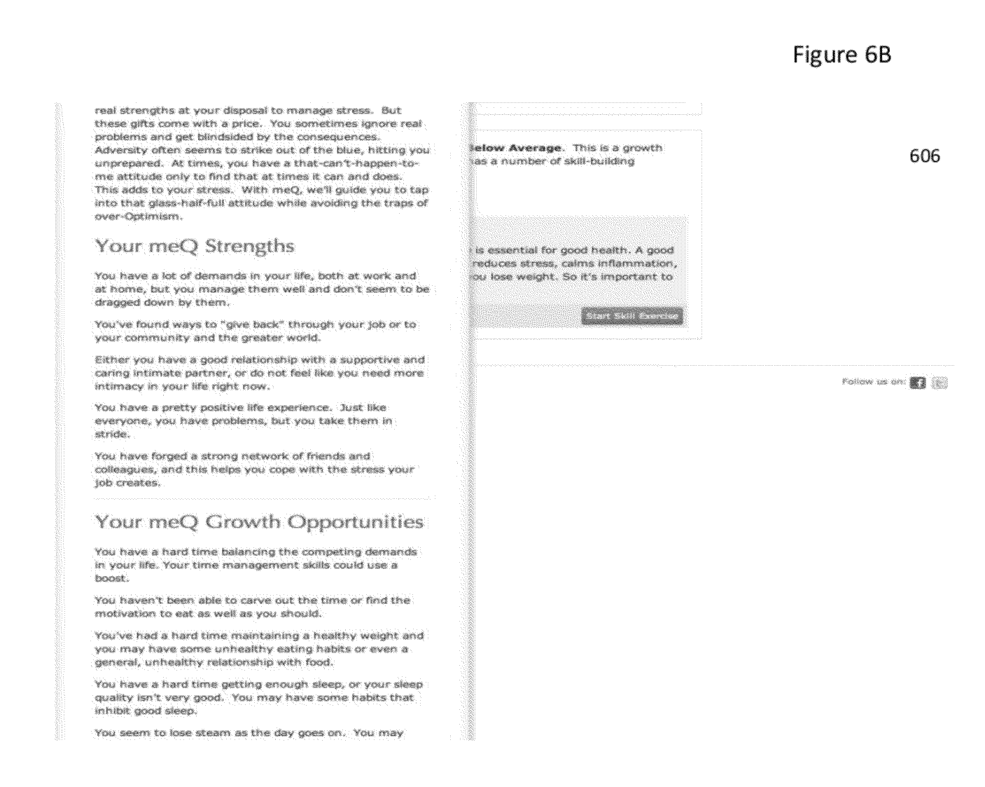

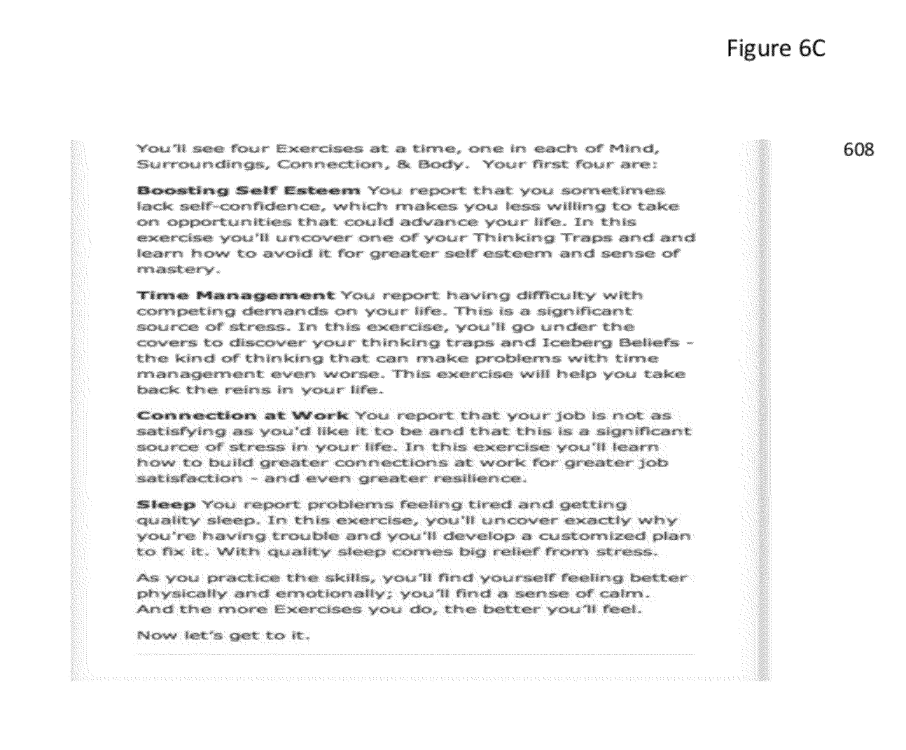

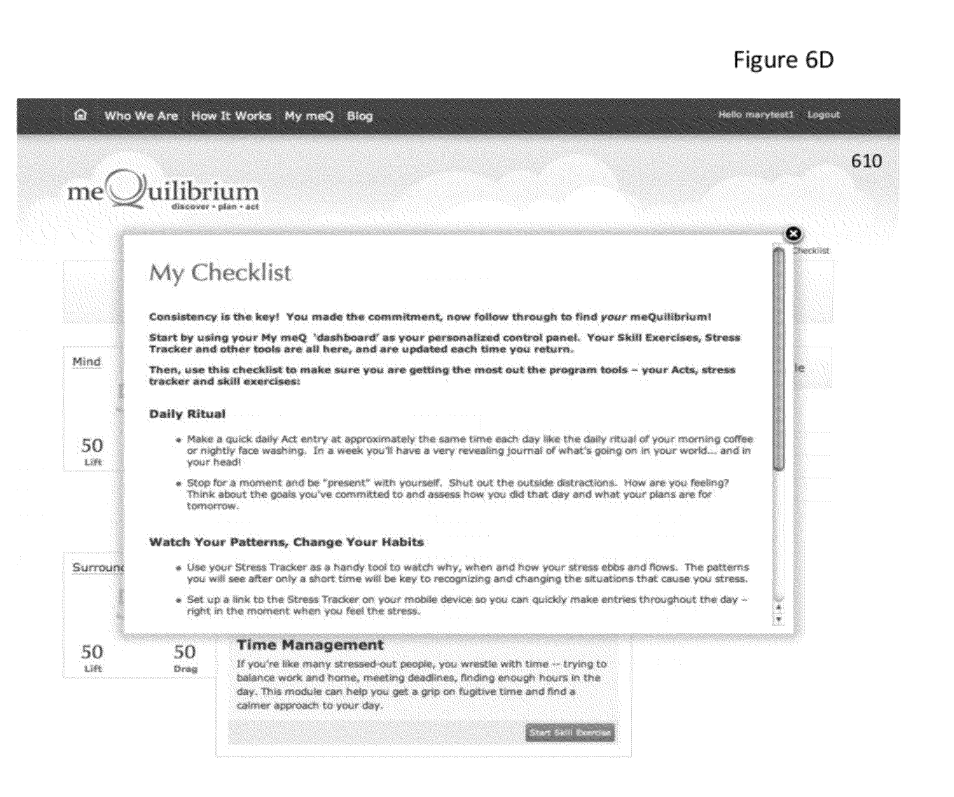

FIG. 5 depicts an exemplary display of an individualized dashboard 502 provided by an embodiment of the present invention. The dashboard 502 depicts for an individual an overall resilience score 504 depicted as the “My meQ” score in FIG. 5 as well as contributing sub-values 506, 508, 510 and 512 from four assessed life dimensions. The values on the dashboard of the present invention may be accompanied by additional information regarding the status of the life dimensions contributing to the current resilience score. For example FIGS. 6A-6E depict exemplary pages 602, 606, 608 and 610 from an individual's dashboard. FIGS. 6A-6E display resilience score 604 and display additional information related to strengths and weaknesses from the life dimensions that contribute to the score.

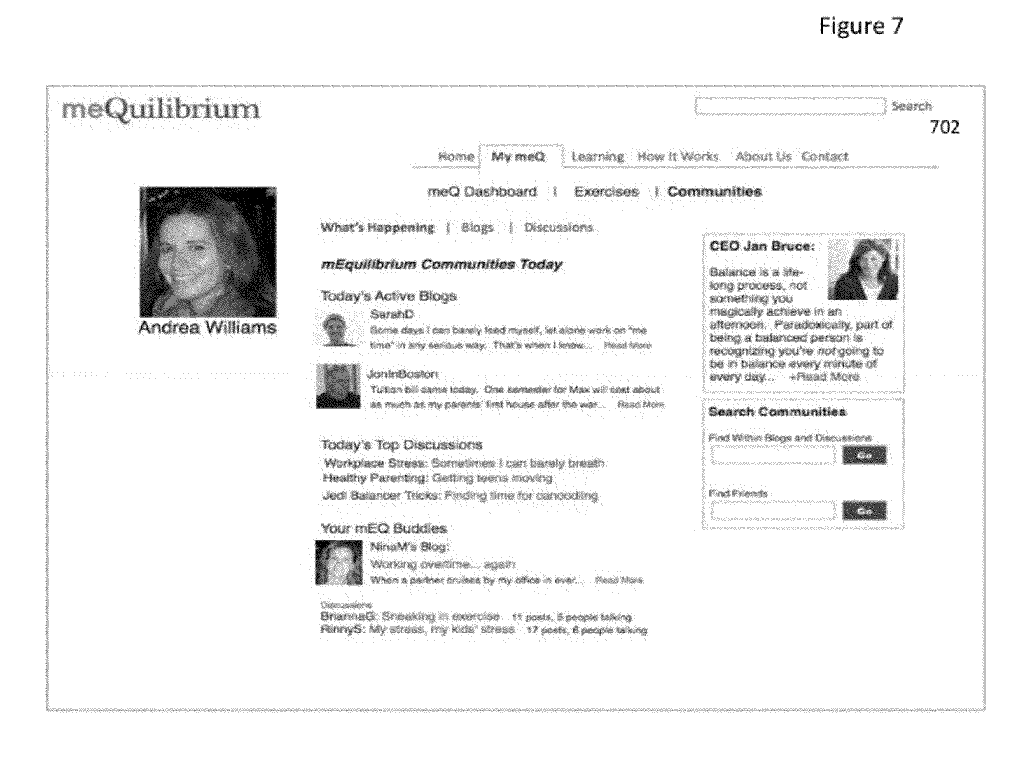

The individualized stress management program created by an embodiment of the present invention may use the initial assessment of the individual to target each individual's specific needs in priority order. For example, the recommended treatment by the stress management program may be based on the principal that the path to a healthier lifestyle is based on increased awareness, systematic skill building and peer support. Through continuous assessment and constant feedback, the stress management program attempts to increase an individual's awareness of their personal maladaptive behaviors and thinking patterns. Individuals track their stress levels, and the context in which that stress occurs, with the intention of gaining a better understanding of themselves and how they react to the world around them. Individuals may have the option of sharing their stress tracking with friends through the dashboard of the lifestyle management platform or through social media sites (with appropriate controls on privacy). For example, FIG. 7 depicts an exemplary community site 702 offered by an embodiment of the present invention through which an individual may share stress levels with others.

The individual stress management program created by an embodiment of the present invention may utilize exercises to systematically build and strengthen positive lifestyle aspects for an individual. The exercises target cognitive, physical and environmental issues as well as the individual's connections to the world. The exercises may be designed to lead an individual through an exploration of their current stress state and may provide skill-building steps that include concrete action steps and plans. The stress management program may continuously evaluate the effectiveness of the exercises and refine and alter future recommendations based on past results and feedback from individuals who have previously completed the exercise.

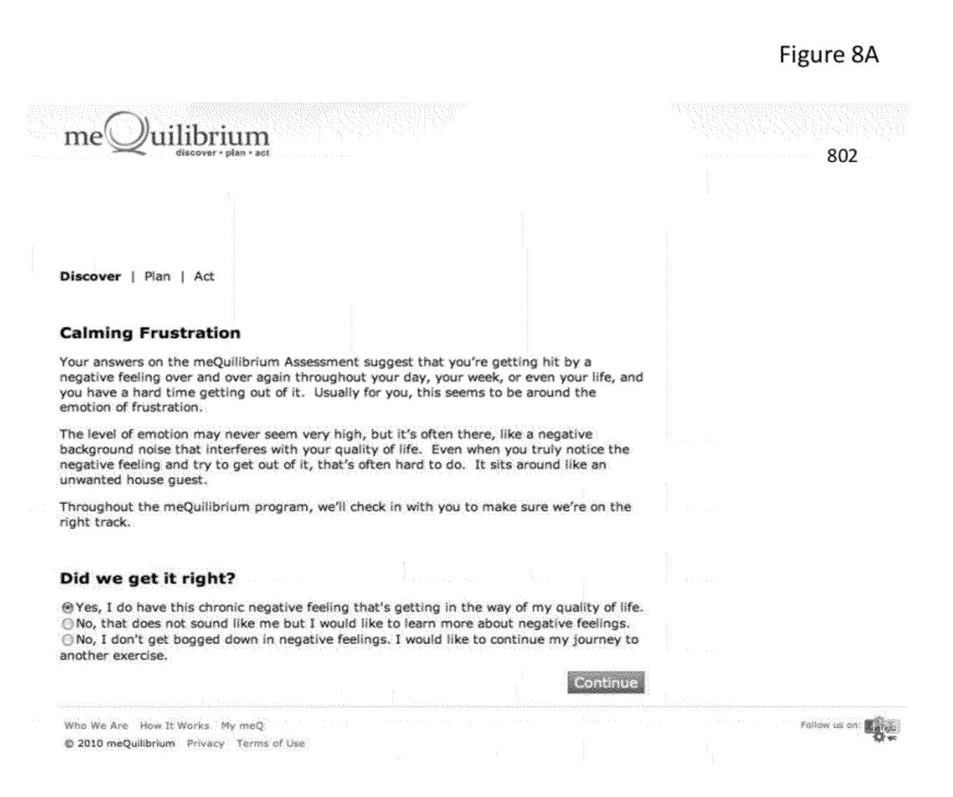

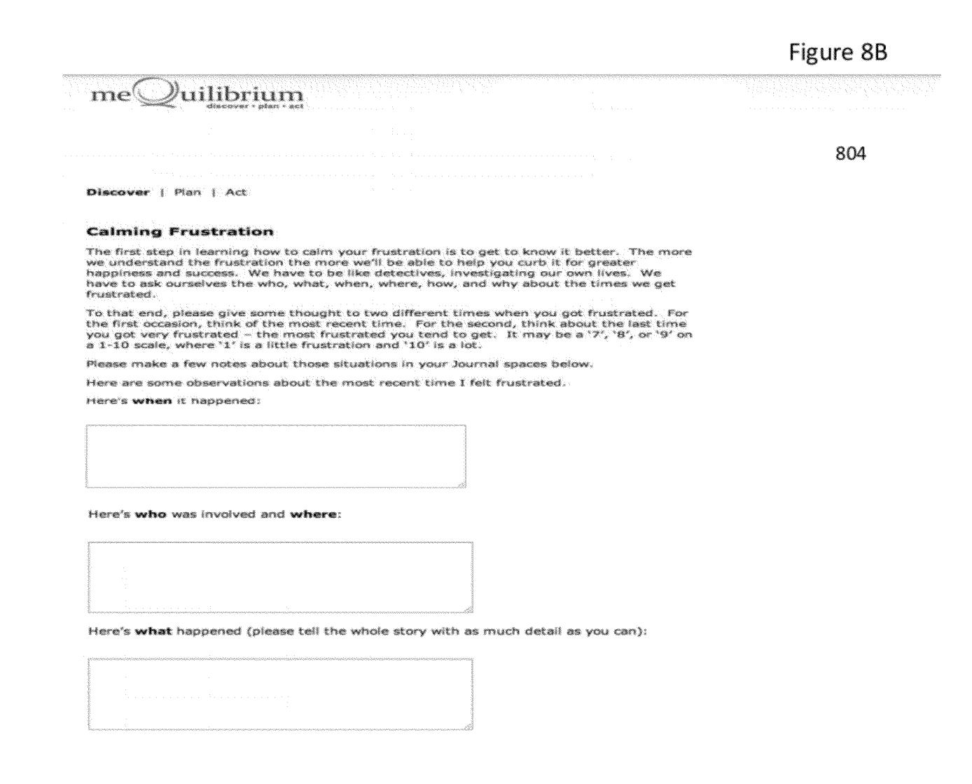

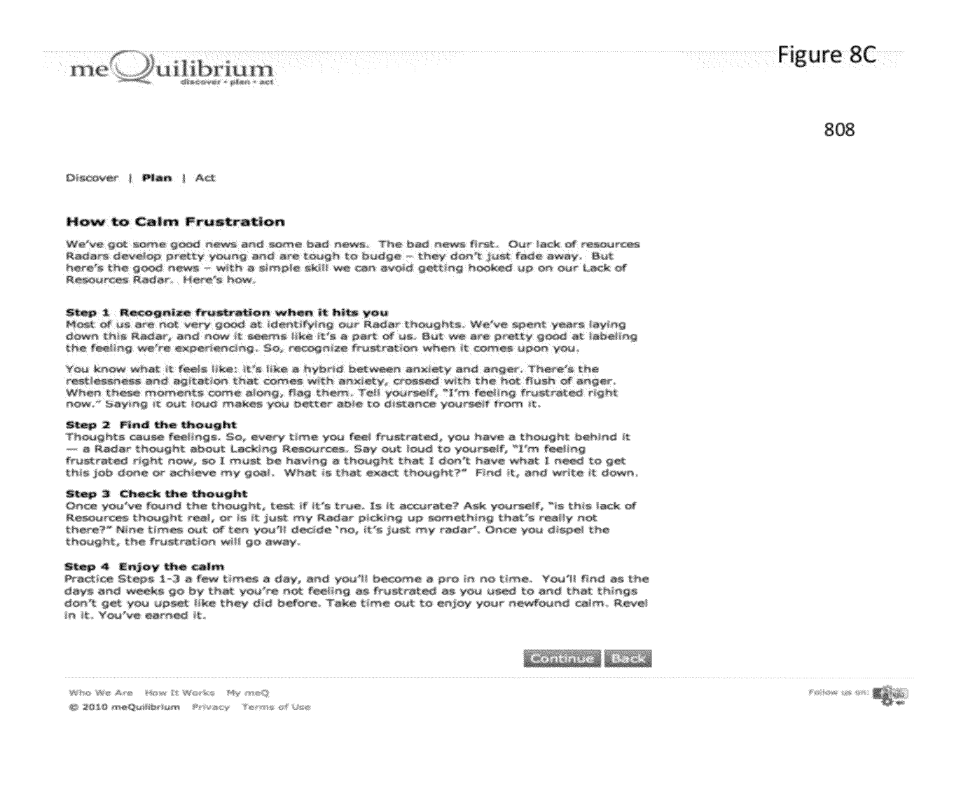

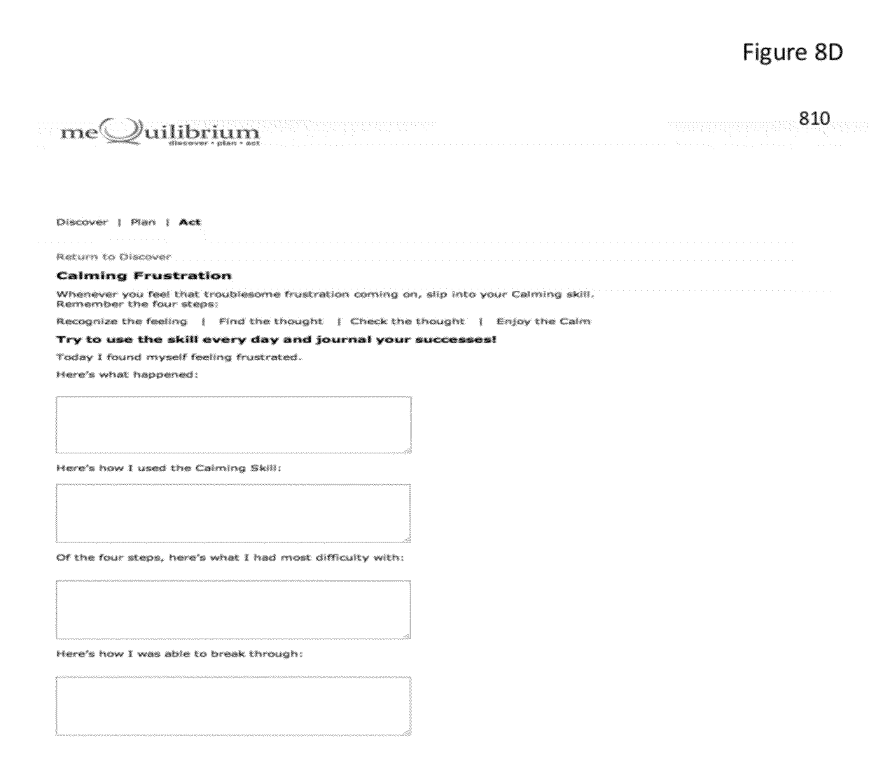

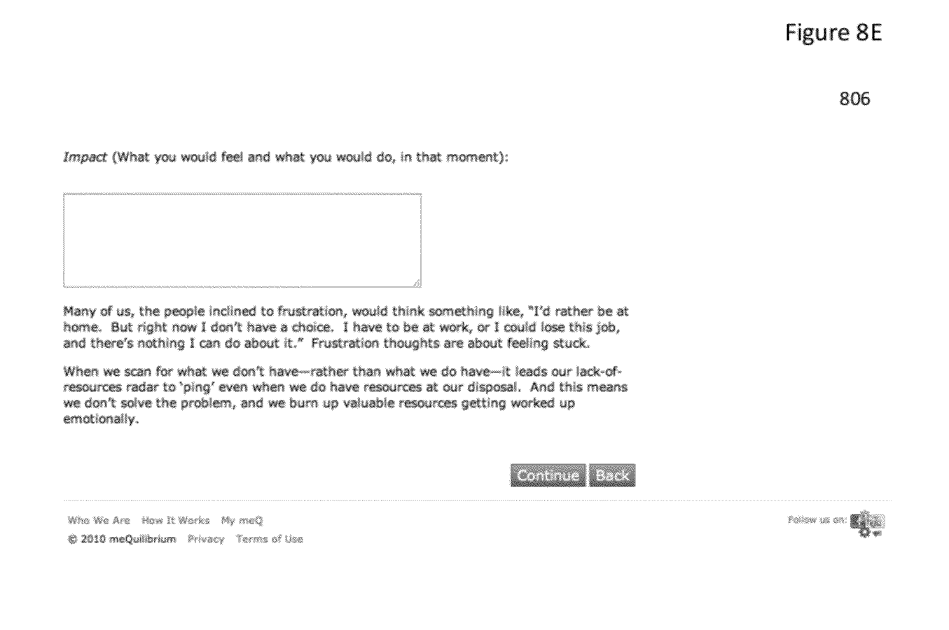

In one embodiment, exercises may be broken down into three basic areas, discover, plan and act. The discover section of the exercise allows the individual to find out the science behind the program and how to use positive psychology techniques to improve their lifestyle. FIGS. 8A-8E depict an exemplary calming exercise provided by an embodiment of the present invention with FIGS. 8A and 8B depicting an exemplary discover section of the calming exercise. The plan section of an exercise includes a user setting that allows an individual to participate in identifying and modifying the behavior that is being changed. The plan section often has many journaling sections that an individual can use to express feeling and emotions. FIGS. 8C depicts an exemplary plan section of the calming exercise. The act section of an exercise may include journaling exercises that allow individuals to express, document and reflect on the learned techniques and how they have implemented them in their lives. The act section may also have an area to modify how these techniques can be used better in the future. FIGS. 8D and 8E depict an exemplary act section of the calming exercise.

The exercises may be assigned based on a series of calculations from the assessment. For example, in one embodiment, based on a person's assessment, a series of over 100 calculations may be made and compared to previously determined norms. Based on these calculations, each exercise is reviewed to determine if it should be assigned to the particular individual. Once an individual has been assigned exercises, the order the individual receives the exercises is based on scientifically-based, pre-determined criteria indicating the order in which the exercises should be allocated. For example, in the Mind dimension, exercises on identified problem emotions for an individual may be given before working on more difficult concepts such as thinking traps. The early focus on identified problems is designed to lead to early positive results and reinforce the individual's commitment to the program. The Connection and Surrounding exercises may be assigned the same way as the Mind exercises. An exemplary way of ordering the assignment of Body exercises is to assign based on lowest body score. It will be appreciated that other ordering mechanisms of assigning exercises are within the scope of the present invention.

The stress management program may also provide peer support to the individual as peer support has been identified as an integral part of a successful transformation of behavior. The lifestyle management platform is utilized in conjunction with social networking, on-line meetings, digital and on-line coaching, etc. to make accessing peer groups easier, more convenient and timelier. With a diverse national and international audience, the lifestyle management platform flexibly programs peer support groups based on client needs and attributes, an advantage over local, geographically bound physical meetings.

Although the description contained herein has focused on a stress management program created using the online lifestyle management platform it should be appreciated that other lifestyle management programs in addition to stress management programs may be generated by the online lifestyle management platform and that such programs are considered to be within the scope of the present invention. For example, instead of receiving a full, customized program, the individual may be directed to a series of time-saving mini-tips or even applications, based on their responses to the online assessment.

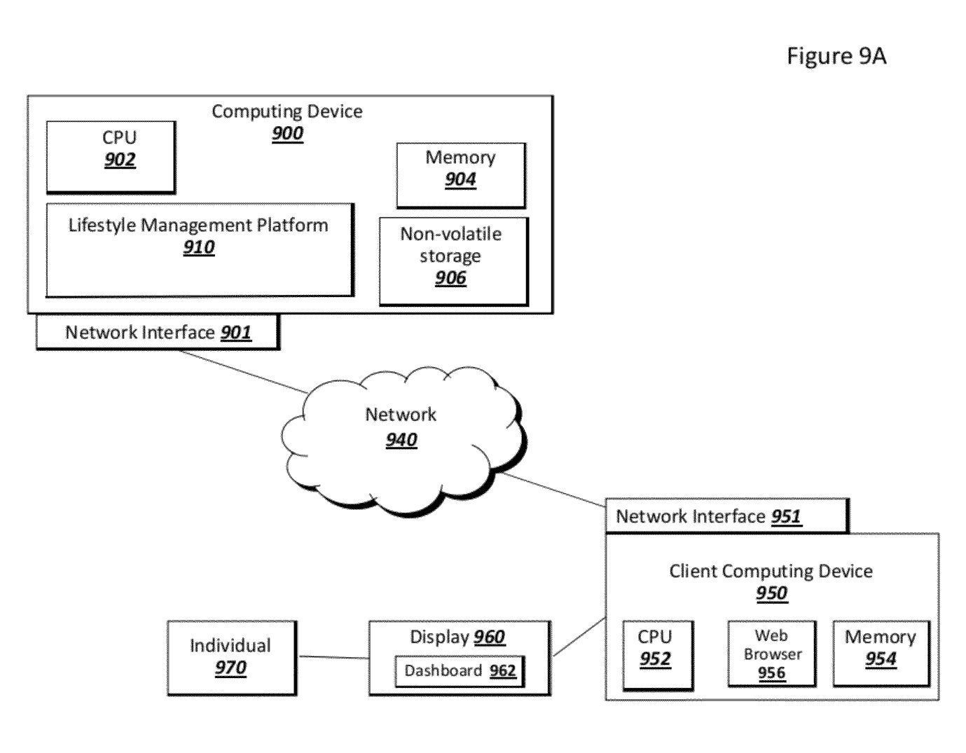

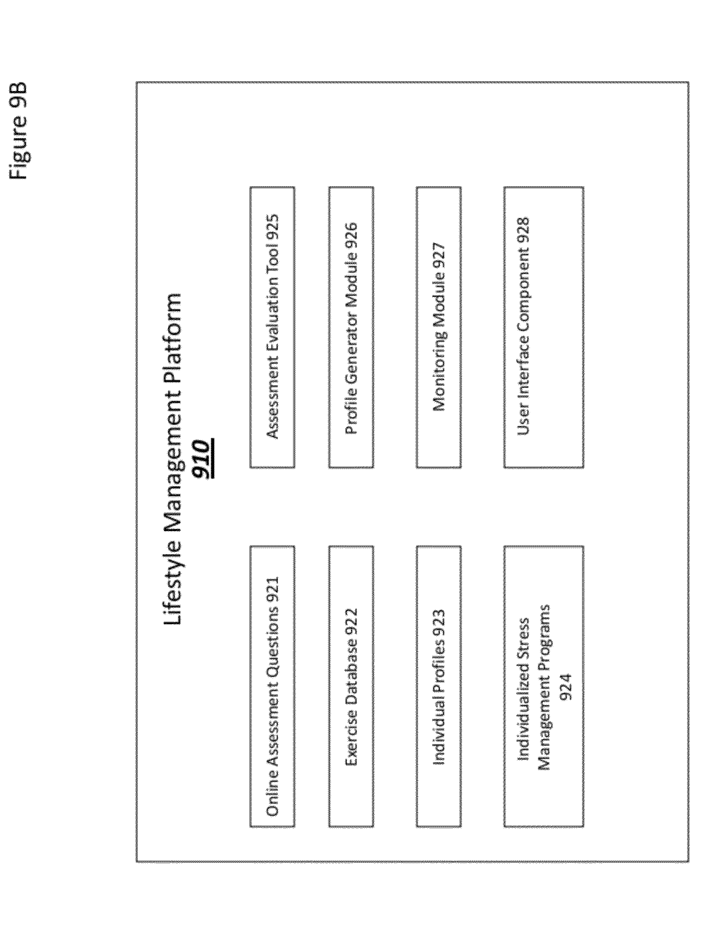

FIG. 9A depicts an exemplary environment suitable for practicing embodiments of the present invention. The exemplary environment may include a computing device 900 equipped with a processor 902 for executing computer-executable instructions. Computing device 900 also includes memory 904 and may include non-volatile storage 906. Computing device 900 hosts the lifestyle management platform 910 which is used to create an individualized lifestyle management program such as a stress management program for an assessed individual. Computing device 900 may be in communication with a client computing device 950 via a network interface 901 over network 940.

Client computing device 950 may communicate via network interface 951 over the network 940 with the computing device 900. It should be appreciated that while client computing device 950 may be a conventional computing device, such as a laptop or desktop PC that is equipped with a CPU 952, memory 954 and web browser 956, client computing device may also be a portable computing device such as a tablet, smartphone or feature phone equipped with a browser and able to access computing device 900 from a remote location. Individual 970 may use web browser 956 to access lifestyle management platform 901 and access an individualized dashboard 962 of the present invention displaying customized information related to the individual's lifestyle management program. Individual 970 may view dashboard 962 on display 960. It will be appreciated that other architectural configurations of the components described herein are also within the scope of the present invention. For example, in an alternative embodiment, the created stress management program of the present invention may be transmitted to the client computing device 950 and be executed on the client computing device rather than on computing device 900.

Computing device 900 is intended to be illustrative and not limiting of the present invention. Computing device 900 may take many forms, including but not limited to a server, personal computer, workstation, network computer, quantum computer, optical computer, bio computer, Internet appliance, mobile device, a pager, a tablet computer, and the like. Computing device 900 may be electronic and may include Central Processing Unit (CPU) 902, memory 904, storage 906, input control, modem, etc. CPU 902 may control each component of computing device 900 to provide lifestyle management platform 910. Memory 904 temporarily stores instructions and data and provides them to CPU 902 so that CPU 902 operates the computing device 900.

Optionally, computing device 900 may include multiple CPUs for executing software loaded in memory 904, and other programs for controlling system hardware. Each of the CPUs can be a single or a multiple core processor. The code loaded in memory 904 may run in a virtualized environment, such as in a Virtual Machine (VM). Multiple VMs may be resident on a single processor. Also, part of the code may be run in hardware, for example, by configuring a field programmable gate array (FPGA), using an application specific instruction set processor (ASIP) or creating an application specific integrated circuit (ASIC). Further, part of the code may be run on analog electronic devices or other resources may be used to run part of the code, such as graphics processing units (GPUs) or dedicated hardware such as Fast Fourier Transform (FFT) processing blocks.

Storage 906 may contain applications. Storage 906 can include code for the operating system (OS) of the computing device 900, code for at least one application executed by the OS including the applications for lifestyle management platform 910 and created stress management programs. Storage 906 may also hold data generated from lifestyle management platform 910. Those of ordinary skill in the art will appreciate that parts of applications can be stored in the CPU cache or memory 904 as well, or they can be stored on a location accessible over the network 940.

Network 940 may be the Internet, an intranet, LAN (Local Area Network), WAN (Wide Area Network), MAN (Metropolitan Area Network), wireless network (e.g., using IEEE 802.13 and Bluetooth), etc. In addition, network 940 may use middleware, such as CORBA (Common Object Request Broker Architecture) or DCOM (Distributed Component Object Model) to allow a computer on the network to communicate directly with another computer or device that is connected to the network. The communication facilities can support distributed implementations of the present invention and may utilize Remote Method Invocation (RMI), Remote Procedure Calls (RCP), Simple Object Access Protocol (SOAP), etc.

FIG. 9B depicts the exemplary lifestyle management platform 910 of the present invention in more detail. The lifestyle management platform 910 includes or has access to a plurality of online assessment questions 921 that may be stored in storage 906 on computing device 900 or in another accessible storage location. The lifestyle management platform also includes or has access to an exercise database 922. The exercise database 922 holds a plurality of exercises which are utilized in forming the individualized stress management programs of the present invention. The lifestyle management platform includes an assessment evaluation tool 925 which automatically scores the online assessment taken by the individual to calculate a resiliency score. A profile generator module 926 of the lifestyle management platform 910 uses the resiliency score to create an individual profile 923 and personalized stress management program 924. The lifestyle management platform 910 further includes a monitoring module 927 that monitors the performance of the individual in following their stress management program 924 through the individual's interaction with the lifestyle management platform. The lifestyle management platform 910 also includes a user interface component 910 providing access to the online assessment and dashboard of the present invention. As discussed above, the components and modules described herein can be combined into a greater or lesser number of components and modules that deliver the same functionality without departing from the scope of the present invention.

Embodiments of the present invention may be provided as one or more non-transitory computer-readable programs embodied on or in one or more physical mediums. For example, the mediums may be a floppy disk, a hard disk, a compact disc, a digital versatile disc, a flash memory card, a PROM, an MRAM, a RAM, a ROM, or a magnetic tape. In general, the computer-readable programs may be implemented in any programming language. Some examples of languages that can be used include FORTRAN, C, C++, C#, Python, FLASH, JavaScript, or Java. The software programs may be stored on, or in, one or more mediums as object code. Hardware acceleration may be used and all or a portion of the code may run on a FPGA, an Application Specific Integrated Processor (ASIP), or an Application Specific Integrated Circuit (ASIC). The code may run in a virtualized environment such as in a virtual machine. Multiple virtual machines running the code may be resident on a single processor.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

We claim:

1. A computing device-implemented online lifestyle management platform, comprising:
an interface to the lifestyle management platform, the interface enabling an individual to undergo an online assessment of the physical and mental status of the individual;
an assessment evaluation tool, the assessment evaluation tool determining a resiliency score for the individual based on the performance of the individual on the online assessment, the resiliency score indicative of the overall mental and physical status of the individual;
a profile generator module, the profile generator module generating a customized physical and psychological profile for the individual based on the resiliency score, the profile used to create a personalized stress management program for the individual; and
a monitoring module, the monitoring module monitoring a subsequent performance of the individual in following the created stress management program, the monitoring module adjusting the profile and resiliency score based on the monitored performance of the individual.

2. The online lifestyle management platform of claim 1 wherein the resiliency score is based on scores for the individual in a plurality of life dimensions tested in the online assessment, the life dimensions being categories associated with aspects of physical and mental health.

3. The lifestyle management platform of claim 2 wherein the life dimensions include at least two of a mind, body, connection and surroundings dimension.

4. The lifestyle management platform of claim 2 wherein the stress management program is composed of a plurality of exercises to be performed by the individual to address aspects of the life dimensions.

5. The lifestyle management platform of claim 4 wherein an order of exercises presented to the individual is based on the profile associated with the individual.

6. The lifestyle management platform of claim 1, further comprising:
a visual dashboard interface, the visual dashboard displaying current information related to the profile of the individual and providing access to different portions of the stress management program.

7. The lifestyle management platform of claim 6 wherein the visual dashboard provides access to an online support community, the online support community including other individuals executing stress management programs generated through the lifestyle management platform.

8. A computing device-implemented method for providing online lifestyle management, comprising:
providing an assessment evaluation tool, the assessment evaluation tool determining a resiliency score for an individual undergoing an online assessment of the physical and mental status of the individual, the resiliency score indicative of the overall mental and physical status of the individual;
generating a customized physical and psychological profile for the individual based on the resiliency score;
creating a personalized lifestyle management program for the individual based on the profile;
monitoring a subsequent performance of the individual in following the created lifestyle management program; and
adjusting the profile and resiliency score based on the monitored performance of the individual.

9. The method of claim 8 wherein the lifestyle management program is a stress management program.

10. The method of claim 9 wherein the resiliency score is based on scores for the individual in a plurality of life dimensions tested in the online assessment, the life dimensions being categories associated with aspects of physical and mental health.

11. The method of claim 10 wherein the life dimensions include at least two of a mind, body, connection and surroundings dimension.

12. The method of claim 10 wherein the stress management program is composed of a plurality of exercises to be performed by the individual to address aspects of the life dimensions.

13. The method of claim 12 wherein an order of exercises presented to the individual is based on the profile associated with the individual.

14. The method of claim 9, further comprising:
displaying a visual dashboard interface, the visual dashboard interface displaying current information related to the profile of the individual and providing access to different portions of the stress management program.

15. The method of claim 14 wherein the visual dashboard interface provides access to an online support community, the online support community including other individuals executing stress management programs generated through the lifestyle management platform.

16. A non-transitory computer-readable medium holding instructions for providing online lifestyle management, the instructions when executed causing at least one computing device to:
provide an assessment evaluation tool, the assessment evaluation tool determining a resiliency score for an individual undergoing an online assessment of the physical and mental status of the individual, the resiliency score indicative of the overall mental and physical status of the individual;
generate a customized physical and psychological profile for the individual based on the resiliency score;
create a personalized lifestyle management program for the individual based on the profile;
monitor a subsequent performance of the individual in following the created lifestyle management program; and
adjust the profile and resiliency score based on the monitored performance of the individual.

17. The medium of claim 16 wherein the lifestyle management program is a stress management program.

18. The medium of claim 17 wherein the resiliency score is based on scores for the individual in a plurality of life dimensions tested in the online assessment, the life dimensions being categories associated with aspects of physical and mental health.

19. The method of claim 18 wherein the life dimensions include at least two of a mind, body, connection and surroundings dimension.

20. The medium of claim 18 wherein the stress management program is composed of a plurality of exercises to be performed by the individual to address aspects of the life dimensions.

21. The medium of claim 20 wherein an order of exercises presented to the individual is based on the profile associated with the individual.

22. The medium of claim 17, further comprising:
displaying a visual dashboard interface, the visual dashboard interface displaying current information related to the profile of the individual and providing access to different portions of the stress management program.

23. The medium of claim 22 wherein the visual dashboard interface provides access to an online support community, the online support community including other individuals executing stress management programs generated through the lifestyle management platform.

24. An online lifestyle management platform, comprising:
an assessment component, the assessment component providing access for an individual to an online assessment of physical and mental stress factors for the individual, the assessment component programmatically calculating a score for the assessment;
a program generation component used to automatically create a personalized stress management program for the individual based on the score; and
a monitoring module, the monitoring module monitoring a subsequent performance of the individual in following the created stress management program and adjusting the score based on the performance.
